(19) United States
(12) Patent Application Publication
(10) Pub. No.: US 2006/0105176 A1
(43) Pub. Date: May 18, 2006

(54) Prepreg and laminate and printed wiring board using the same

(76) Inventors: Yoshiyuki Narabu, Chikusei-shi (JP); Kazunaga Sakai, Oyama-shi (JP); Miki Satou, Oyama-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/274,413

(22) Filed: Nov. 16, 2005

(30) Foreign Application Priority Data
Nov. 16, 2004 (JP) P2004-331768
Jun. 1, 2005 (JP) P2005-161507

(51) Int. Cl. B32B 27/04; B32B 27/38; C08L 63/00

(52) U.S. Cl. 428/416; 428/414; 428/413; 428/447; 428/297.4

(57) ABSTRACT

A paper base material is impregnated in advance with a Composition containing an alkoxysilane derivative and/or condensate of an alkoxysilane derivative. The paper base material is then impregnated with a thermosetting resin composition containing a phenolic resin, followed by heating and drying to obtain a prepreg. A laminate and a printed wiring board are produced with the use of the prepreg. The prepreg is halogen free and is excellent in heat resistance, flame retardancy, punching processability, and insulation.

### BACKGROUND OF THE INVENTION

1. Field of the Invention

The present invention relates to a prepreg as well as a laminate and a printed wiring board using the same, and more particularly to a prepreg impregnated with phenolic resin being excellent in heat resistance, flame retardancy, punching processability, and insulation, as well as a phenolic resin laminate and a printed wiring board using the same.

2. Description of the Related Art

In accordance with the downsizing and multiple functionality of electronic devices in recent years, the printed wiring boards now have a higher density and a smaller scale. Among these, paper base material phenolic resin copper-clad laminates are excellent in punching processability and drilling processability and also are inexpensive, so that the laminates are widely used as substrates for printed wiring boards in electronic devices for general public.

A paper base material phenolic resin laminate is produced by superposing a predetermined number of sheets of prepreg obtained by impregnating a paper base material with a phenolic resin varnish an drying, followed by hearing and pressing. Typically, after a predetermined number of sheets of the prepreg are superposed, a copper foil is disposed on one or both surfaces thereof, followed by heating and pressing to produce a copper-clad laminate. Also, a printed wiring board can be produced by etching the copper foil of the copper-clad laminate to form a circuit.

However, since a paper base material phenolic resin copper-clad laminate has a lower heat resistance than a glass base material epoxy resin copper-clad laminate, the temperature in a reflow step must be set to be low so as not to generate an inconvenience such as swelling.

In the meantime, according as people are more and more conscious about the protection of environments in recent years, adoption of a halogen-free material that does not use a halogen-based flame retardant or a lead-free solder that does not use lead which is a harmful substance is increasing. A halogen-free material requires use of a phosphorus-based, nitrogen-based, inorganic-based flame retardant in a large amount and with a good balance in place of a halogen-based flame retardant. Therefore, it is extremely difficult to improve heat resistance of a resin base material which is greatly affected by heat resistance of these flame retardants. Moreover, lead-free solders have a higher melting point than conventional lead-containing solders (Sn—Pb), so that the temperature in the reflow step must be set to be high, thereby demanding a higher hear resistance of base materials than in the past.

Accordingly, there is a strong demand for development of a paper base material phenolic resin copper-clad laminate being halogen free and being excellent in both flame retardancy and heat resistance. Further, in a two-sided printed wiring board using the laminate, silver through-holes are often used for establishing electrical connection between the circuits on the two surfaces, so that it is important to ensure the insulation reliability between the through-holes.

As a method for improving flame retardancy and the humidity resistance of a phenolic resin laminate, a method of impregnating a fiber base material with a water-soluble melamine resin or a water-soluble phenolic resin and subsequently impregnating it with a drying oil denatured phenolic resin (See Japanese Patent Application Publication No. 38-13781). Also, as a method for improving the tracking resistance of a phenolic resin laminate, a method of adding aluminum hydroxide or the like has been used (See, for example, Japanese Patent Application Publication No. 55-49640). Further, as a method of improving punching processability of a phenolic resin laminate, addition of an external plasticizer such as a phosphoric acid ester has been studied (See, for example, Japanese Patent Application Publication No. 57-19127). However, these methods cannot satisfy all the characteristics as a whole though the methods can respectively satisfy individual characteristic values demanded in a phenolic resin laminate.

Also, Japanese Patent Application Laid-Open No. 2004-356277 discloses improvement of the curability and heat resistance of a phenolic resin by blending the phenolic resin with an epoxy resin However, in this case, flame retardancy of the resin decreases and, depending on the epoxy resin to be used, there will be a considerable decrease in the storage stability of the varnish and prepreg.

### SUMMARY OF THE INVENTION

In view of the above, the invention aims at providing a prepreg being halogen free and being excellent in heat resistance, flame retardancy, punching processability, and insulation as well as a laminate and a printed wiring board using the same

Namely, the invention is characterized by the following matters described in (1) to (19).

(1) A prepreg obtained by impregnating a paper base material in advance with a composition containing an alkoxysilane derivative and/or condensate of an alkoxysilane derivative, and then impregnating the paper base material with a thermosetting resin composition containing a phenolic resin, followed by heating and drying.

(2) The prepreg of above (1), wherein said alkoxysilane derivative and/or condensate of an alkoxysilane derivative has at least one epoxy group.

(3) The prepreg of above (1) or (2), wherein said alkoxysilane derivative has a structure represented by the following formula: 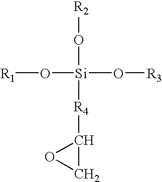
where R₁ to R₃ are independently a hydrogen atom or an alkyl group having one to four carbon atoms, and R₄ is a divalent organic group.

(4) The prepreg of any one of above (1) to (3), wherein said composition containing an alkoxysilane derivative and/or condensate of an alkoxysilane derivative further contains a water-soluble phenolic resin, and contains 0.5 to 10 wt % of said alkoxysilane derivative and/or condensate of an alkoxysilane derivative.

(5) The prepreg of any one of above (1) to (4), wherein said thermosetting resin composition further contains 2 to 30 parts by weight of an epoxy resin relative to 100 parts by weight of said phenolic resin.

(6) The prepreg of any one of above (1) to (5), wherein said phenolic resin is a vegetable oil denatured phenolic resin.

(7) The prepreg of any one of above (1) to (6), wherein said thermosetting resin composition further contains a halogen-free nitrogen-based flame retardant and/or phosphorus-based flame retardant.

(8) The prepreg of any one of above (1) to (4), wherein said phenolic resin is a vegetable oil denatured resol-type phenolic resin, and said thermosetting resin composition farther contains an epoxy resin, a melamine denatured novolak-type phenolic resin, and a phosphoric acid ester.

(9) The prepreg of any one of above (1) to (4), wherein said phenolic resin is a vegetable oil denatured resol-type phenolic resin, and said thermosetting resin composition further contains 5 to 40 parts by weight of an epoxy resin, 70 to 150 parts by weight of a melamine denatured novolak-type phenolic resin, and 30 to 80 parts by weight of a phosphoric acid ester relative to 100 parts by weight of the vegetable oil denatured resol-type phenolic resin.

(10) The prepreg of above (8) or (9), wherein aweigh per epoxy equivalent of said epoxy resin is 400 to 1000 g/eq.

(11) The prepreg of any one of above (5) to (10), wherein said epoxy resin is a bisphenol A type epoxy resin that does not contain a halogen.

(12) A laminate obtained by superposing a predetermined number of sheets of a prepreg according to any one of above (1) to (11), followed by heating and pressing.

(13) A metal-clad laminate obtained by superposing a predetermined number of sheets of a prepreg according to any one of above (1) to (11) and then disposing a metal foil on one or both surfaces thereof, followed by heating and pressing.

(14) A printed wiring board obtained by etching a metal layer of a metal-clad laminate according to above (13).

(15) A resin composition containing a vegetable oil denatured resol-type phenolic resin, an epoxy resin, a melamine denatured novolak-type phenolic resin, and a phosphoric acid ester, wherein the epoxy resin has a weight per epoxy equivalent of 400 to 1000 g/eq.

(16) The resin composition of above (15), containing 5 to 40 parts by weight of said epoxy resin, 70 to 150 parts by weight of said melamine denatured novolak-type phenolic resin, and 30 to 80 parts by weight of said phosphoric acid ester relative to 100 parts by weight of said vegetable oil denatured resol-type phenolic resin.

(17) A prepreg obtained by impregnating a base material with a resin composition according to above (15) or (16), followed by drying.

(18) A laminate obtained by superposing a predetermined number of sheets of a prepreg according to above (17), followed by heating and pressing.

(19) A metal-clad laminate obtained by superposing a predetermined number of sheets of a prepreg according to above

(17) and then disposing a metal foil on one or both surfaces thereof, followed by heating and pressing.

The invention such as described above can provide a prepreg that is halogen free and excellent in heat resistance, flame retardancy, punching processability, and insulation, and that does not generate an inconvenience such as swelling even in a reflow step having a temperature set at about 250° C., as well as a laminate and a printed wiring board using the same.

This application claims priority based on Japanese patent applications filed by the applicants of the present application, namely Japanese Patent Application Nos. 2004-331768 (filed on Nov. 16, 2004) and 2005-161507 (filed on Jun. 1, 2005), the contents of whose specifications are incorporated herein by reference.

### DESCRIPTION OF THE PREFERRED EMBODIMENT(S)

A prepreg of the invention is characterized in that it is produced by impregnating a paper base material in advance with a composition containing an alkoxysilane derivative and/or condensate of an alkoxysilane derivative (which may hereafter be abbreviated as alkoxysilane derivative containing composition) and then impregnating the paper base material with a thermosetting resin composition containing a phenolic resin, followed by heating and drying.

The aforesaid alkoxysilane derivative is not particularly limited; however, it may be a compound such as tetrafunctional silane compound, trifunctional silane compound, or bifunctional silane compound. These alkoxysilane derivatives may be used either alone or as a combination of two or more kinds thereof (hereafter, the term “functionality” in the silane compounds will be used to mean that they have a condensation-reactive functional group).

Examples of tetrafunctional silane compounds such as tetraalkoxysilane include Si(OCH₃)₄, Si(OC₂H₅)₄, Si(OC₃H₇)₄, Si(OC₄H₉)₄, and others.

Examples of trifunctional silane compounds such as Trialkoxysilane include H₃CSi(OCH₃)₃, H₅C₂Si(OCH₃)₃, H₇C₃Si(OCH₃)₃, H₉C₄Si(OCH₃)₃, H₃CSi(OC₂H₅)₃, H₅C₂Si(OC₂H₅)₃, H₇C₃Si(OC₂H₅)₃, H₉C₄Si(OC₂H₅)₃, H₃CSi(OC₃H₇)₃, H₅C₂Si(OC₃H₇)₃, H₇C₃Si(OC₃H₇)₃, H₉C₄Si(OC₃H₇)₃, H₃CSi(OC₄H₉)₃, H₅C₂Si(OC₄H₉)₃, H₇C₃Si(OC₄H₉)₃, H₉C₄Si(OC₄H₉)₃, (CH₂OCH)CH₂Si(OCH₃)₃, (CH₂OCH)CH₂Si(OC₂H₅)₃, (CH₂OCH)CH₂Si(OC₃H₇)₃ having a glycidyl group (CH₂OCH—), further CH₂═CHSi(OCH₃)₃, HSC₃H₆Si(OCH₃)₃, H₂NC₃H₆Si(OCH₃)₃, CH₂═CHSi(OC₂H₅)₃, HSC₃H₆Si(OC₂H₅)₃, H₂NC₃H₆Si(OC₂H₅)₃, CH₂═CHSi(OC₃H₇)₃, HSC₃H₆Si(OC₃H₇)₃, H₂NC₃H₆Si(OC₃H₇)₃, PhSi(OCH₃)₃, PhSi(OC₂H₅)₃, PhSi(OC₃H₇)₃, PhSi(OC₄H₉)₃ (here, Ph represents a phenyl group; the same applies hereafter), and others.

Examples of bifunctional silane compounds such as dialkoxysilane include ((CH₂OCH)CH₂)₂Si(OCH₃)₂, (CH₂═CH)₂Si(OCH₃)₂, (HSC₃H₆)₂Si(OCH₃)₂, (H₂NC₃H₆)₂Si(OCH₃)₂, ((CH₂OCH)CH₂)₂Si(OC₂H₅)₂, (CH₂═CH)₂Si(OC₂H₅)₂, (HSC₃H₆)₂Si(OC₂H₅)₂, (H₂NC₃H₆)₂Si(OC₂H₅)₂, ((CH₂OCH)CH₂)₂Si(OC₃H₇)₂, (CH₂═CH)₂Si(OC₃H₇)₂, (HSC₃H₆)₂Si(OC₃H₇)₂, (H₂NC₃H₆)₂Si(OC₃H₇)₂, (H₃C)₂Si(OCH₃)₂, (H₅C₂)₂Si(OCH₃)₂, (H₇C₃)₂Si(OCH₃)₂, (H₉C₄)₂Si(OCH₃)₂, (H₉C)₂Si(OC₂H₅)₂, (H₅C₂)₂Si(OC₂H₅)₂, (H₇C₃)₂Si(OC₂H₅)₂, (H₉C₄)₂Si(OC₂H₅)₂, (H₃C)₂Si(OC₃H₇)₂, (H₅C₂)₂Si(OC₃H₇)₂, (H₇C₃)₂Si(OC₃H₇)₂, (H₉C₄)₂Si(OC₃H₇)₂, (H₃C)₂Si(OC₄H₉)₂, (H₅C₂)₂Si(OC₄H₉)₂, (H₇C₃)₂Si(OC₄H₉)₂, (H₉C₄)₂Si(OC₄H₉)₂, Ph₂Si(OCH₃)₂, Ph₂Si(OC₂H₅)₂, and others,

A condensate of the above alkoxysilane derivative can be obtained by condensation of the above alkoxysilane derivative. A single or a combination of several kinds of condensate of alkoxysilane derivative may be used, and may be used in combination with alkoxysilane derivatives. In condensation, it is preferable to select and use an inorganic acid such as hydrochloric acid, sulfuric acid, phosphoric acid, nitric acid, or hydrofluoric acid, organic acid such as maleic acid, sulfonic acid, oxalicacid, or formic acid as a catalyst, or a basic catalyst such as ammonia, trimethylamine, triethylamine, or tributylamine depending on the kind of the alkoxysilane derivative to be condensed. The blending amount of these catalysts is not particularly limited; however, the catalysts are used preferably within a range of 0.001 to 0.5 mol with respect to 1 mol of the alkoxysilane derivative. Also, the condensation is preferably carried out in a solvent such as acetone, methyl ethyl ketone, toluene, xylene, ethyl acetate, methanol, or ethanol. Also, in this condensation, a suitable amount of water is needed. It is preferable to use 0.1 to 5 mol, more preferably 0.3 to 4 mol, of water with respect to 1 mol of the alkoxysilane derivative. When more than 5 mol of water is used, the condensation may proceed too rapidly and the product may become a gel When less than 0.1 mol of water is used, the condensation may not proceed sufficiently.

The aforesaid alkoxysilane derivative or condensate of an alkoxysilane derivative preferably has at least one epoxy group (glycidyl group), and the alkoxysilane derivative preferably has a structure represented by the following formula: 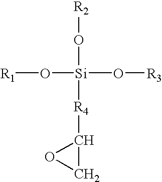
(where R₁ to R₃ are independently a hydrogen atom or an alkyl group having one to four carbon atoms, and R₄ is a divalent organic group). In other words, an alkoxysilane derivative having a reactive group such as an epoxy group (glycidyl group) reacts with a phenolic resin contained in the aforesaid thermosetting resin composition to improve the adhesiveness at the interface between the paper base material and the thermosetting resin. Among these, trimethoxy(glycidylmethyl)silane (CH₂OCH)CH₂Si(OCH₃)₃ having a structure represented by the above formula has a high reactivity and has an affinity when the paper base material is impregnated with it, so that it is especially preferable.

The aforesaid alkoxysilane derivative containing composition preferably contains 0.5 to 10 wt %, preferably 5 to 10 wt %, of an alkoxysilane derivative and/or condensate of an alkoxysilane derivative. When the composition contains less than 0.5 wt % of an alkoxysilane derivative and/or condensate of an alkoxysilane derivative, the effect of heat resistance improvement is small. When the composition contains more than 10 wt % of an alkoxysilane derivative and/or condensate of an alkoxysilane derivative, the deterioration of insulation resistance after humidity absorption process is large, so that the reliability of the through-holes tends to decrease.

Also, when the amount of water in the alkoxysilane derivative containing composition is too small, the condensation of the alkoxysilane derivative does not sufficiently proceed, thereby raising a fear that the effect of heat resistance improvement will decrease. When the amount of water is too large, the storage stability tends to be aggravated. Therefore, it is necessary that water and alcohol are blended with a good balance in the composition. The ratio thereof is preferably 1 to 7:7 to 1, more preferably 4 to 6:6 to 4, in terms of a weight ratio. The kind of alcohol that is used here is not particularly limited; however, use of methanol having a low boiling point is preferable because heating and drying will be easy.

Also, it is more preferable that the alkoxysilane derivative containing composition contains a water-soluble phenolic resin and contains 0.5 to 10 wt % of an alkoxysilane derivative and/or condensate of an alkoxysilane derivative. By blending a water-soluble phenolic resin with the composition, the adhesion at the interface between the paper base material impregnated with the composition and the phenolic resin containing thermosetting resin composition can be improved. Further, it is particularly preferable that the alkoxysilane derivative containing composition contains 0.5 to 10 wt % of an alkoxysilane derivative and/or condensate of an alkoxysilane derivative and 1 to 50 wt % of a water-soluble phenolic resin (solid component). The kind of water-soluble phenolic resin that is used here may be a known one and is not particularly limited; however, a water-soluble phenolic resin can be obtained, for example, by allowing phenol and formalin to react at 50 to 80° C. for 2 to 10 hours in an aqueous solution of triethylamine.

Also, the paper base material that is used in the invention is impregnated with the aforesaid alkoxysilane derivative containing composition, followed by heating and drying. This promotes condensation of the alkoxysilane derivative, and can improve the hydrophobicity of the paper base material. The paper base material before performing the process of impregnation with the above composition is not particularly limited. Examples of the paper base material include kraft paper, cotton linter paper, mixed paper of linter and kraft pulp, mixed paper of glass fiber and paper fiber, and others in view of punching processability.

The phenolic resin contained in the above thermosetting resin composition is not particularly limited; however, the phenolic resin is preferably a vegetable oil denatured phenolic resin, and more preferably a vegetable oil denatured resol-type phenolic resin. A vegetable oil denatured phenolic resin can be obtained, for example, by allowing a phenol and a vegetable oil to react in the presence of an acid catalyst such as p-toluenesulfonic acid, and then allowing an aldehyde to react in the presence of a base catalyst such as ammonia or amine-based catalyst such as trimethylamine or triethylamine. The aforesaid phenol is not particularly limited; however, examples thereof include phenol, m-cresol, p-cresol, o-cresol, isopropylphenol, nonylphenol, bisphenol A, and others. Examples of the aforesaid aldehyde include formaldehyde, paraformaldehyde, acetaldehyde, paraacetaldehyde, butylaldehyde, octylaldehyde, benzaldehyde, and others. The aforesaid vegetable oil is not particularly limited; however, the vegetable oil is preferably a drying oil such as lung oil, linseed oil, dehydrated castor oil, or oiticica oil. The ratio of denaturing by the vegetable oil is preferably set to be 5 to 35wt % in view of punching processability and flame retardancy.

Also, the aforesaid thermosetting resin composition preferably contains an epoxy resin in addition to a phenolic resin, and more preferably contains 2 to 30 parts by weight of an epoxy resin with respect to 100 parts by weight of the phenolic resin. When the content of the epoxy resin exceeds 30 parts by weight, the reaction with an un reacted phenolic resin proceeds, and the storage stability tends to be aggravated. On the other hand, when the content of the epoxy resin is below 2 parts by weight, the effect of improving heat resistance due to addition of the epoxy resin tends to decrease. Here, when the aforesaid vegetable oil denatured resol-type phenolic resin is to be used as a phenolic resin contained in the aforesaid thermosetting resin composition, it is preferable to blend 5 to 40 parts by weight of the epoxy resin with respect to 100 parts by weight of the phenolic resin in view of punching processability, flame retardancy, and heat resistance.

The aforesaid epoxy resin is not particularly limited; however, the epoxy resin is preferably a bisphenol A type epoxy resin which is in liquid form and does not contain a halogen. Further, the weight per epoxy equivalent of the epoxy resin is preferably 170 to 700 g/eq. Here, it is particularly preferable that the weight per epoxy equivalent of the epoxy resin in the case of using a vegetable oil denatured resol-type phenolic resin as the phenolic resin contained in the thermosetting resin composition is 400 to 1000 g/eq. When the weight per epoxy equivalent is below 170 g/eq, the reaction with the phenolic resin proceeds during the storage, and the varnish or prepreg characteristics tend to be deteriorated. When the weight per epoxy equivalent exceeds 1000 g/eq, the reactivity with the phenolic resin decreases, and sufficient heat resistance is unlikely to be obtained.

Also, various plasticizers and flame retardants may be added to the aforesaid thermosetting resin composition in order to impart plasticity and flame retardancy to the laminate. Basically, however, the additives are preferably halogen free. Therefore, as the aforesaid flame retardant, it is preferable To use a commercially available nitrogen-based flame retardant or phosphorus-based flame retardant instead of a halogen-based flame retardant.

The aforesaid nitrogen-based flame retardant may be, for example, a melamine resin, a benzoguanamine resin, or the like, and is not particularly limited; however, it is preferable to use a melamine denatured phenolic resin, more preferably a melamine denatured novolak-Type phenolic resin. The melamine denatured phenolic resin preferably has a nitrogen content of 3 to 20 wt %, more preferably 3 to 15 wt %. When this nitrogen content is below 3 wt %, flame retardancy tends to be deteriorated. When The nitrogen content exceeds 20 wt %, punching processability and heat resistance tend to be deteriorated. Also, the melamine denatured phenolic resin is preferably blended within a range of 5 to 30 parts by weight, more preferably within a range of 10 to 20 parts by weight, relative to 100 parts by weight of the phenolic resin contained in the thermosetting resin composition (excluding the melamine denatured phenolic resin. In the present invention, the same applies when referring to “phenolic resin contained in a thermosetting resin composition”) When the amount of the blended melamine denatured phenolic resin is below 5 parts by weight, there is a fear that the effect of imparting flame retardancy and heat resistance will be insufficient. When the amount exceeds 30 parts by weight, punching processability and the workability tend to be aggravated. However, in the case of using a melamine denatured novolak-type phenolic resin as a nitrogen-based flame retardant and using a vegetable oil denatured resol-type phenolic resin as a phenolic resin contained in the thermosetting resin composition, it is especially preferable to blend 70 to 150 parts by weight of the melamine denatured novolak-type phenolic resin with respect to 100 parts by weight of the vegetable oil denatured resol-type phenolic resin. Further, in this case, it is especially preferable to blend the aforesaid epoxy resin within a range of 2 to 20 wt % with respect to the sum of the amounts of the aforesaid vegetable oil denatured resol-type phenolic resin and melamine denatured novolak-type phenolic resin. This can improve punching processability and heat resistance.

The aforesaid phosphorus-based flame retardant is not particularly limited; however, it is preferably a phosphoric acid ester such as triethyl phosphate, tributyl phosphate, triphenyl phosphate, tricresyl phosphate, cresyl diphenyl phosphate, resorcyl diphenyl phosphate, or triisopropylphenyl phosphate, for example. Among these, triphenyl phosphate is more preferable because it is inexpensive. These can be used either as one kind or as a mixed system of two or more kinds, The phosphorus-based flame retardant is preferably blended within a range from 10 to 100 parts by weight with respect to 100 parts by weight of the phenolic resin contained in the thermosetting resin composition. When the amount of the blended phosphorus-based flame retardant is below 10 parts by weight, the effect of blending will be small. When the amount exceeds 100 parts by weight, punching processability tends to be aggravated, and also other characteristics such as moisture absorptivity tend to decrease Here, in the case of using a vegetable oil denatured resol-type phenolic resin as the phenolic resin, it is especially preferable to blend 30 to 80 parts by weight of the aforesaid phosphorus-based flame retardant with respect to 100 parts by weight of the phenolic resin.

Also, in addition to the above nitrogen-based and phosphorus-based flame retardants, it is preferable to blend inorganic filler-based flame retardants such as aluminum hydroxide within a range up to 50 parts by weight among 100 parts by weight of the total flame retardants. When flame retardants other than phosphorus-based or nitrogen-based flame retardants are blended, flame retardancy can be enhanced to a greater extent with a small amount of blending by synergistic effect, so that the total amount of blended flame retardants can be reduced. However, when the amount of the blended flame retardants other than nitrogen-based or phosphorus-based flame retardants exceed 50 parts by weight, punching processability and heat resistance tend to be aggravated.

It is preferable that the aforesaid thermosetting resin composition is formulated with a solvent such as methanol, toluene, or acetone, and is dissolved or dispersed therein to form a thermosetting resin varnish, and the paper base material is impregnated with the thermosetting resin varnish. Also, the prepreg of the invention is not particularly limited; however, the prepreg preferably contains 15 to 25 wt % of the aforesaid alkoxysilane derivative containing composition, and preferably contains 45 to 60 wt % of the aforesaid thermosetting resin composition.

The laminate of the invention can be produced by superposing a predetermined sheets of the prepreg of the invention, followed by heating and pressing. Also, the metal-clad laminate of the invention can be produced by superposing a predetermined number of sheets of the prepreg and subsequently disposing a metal foil such as a copper foil on one or both surfaces thereof, followed by heating and pressing in the same manner as described above. The thickness of the aforesaid metal foil is not particularly limited; however, it is typically 3 to 200 μm. Further, the aforesaid heating and pressing steps are carried out preferably at a temperature of 150 to 180° C. and under a pressure of 9 to 20 MPa; however, the conditions for healing and pressing can be suitably determined by considering the prepreg characteristics, the reactivity of the resin composition, the performance of the pressing machine, the thickness of the desired laminate, and the like, so that the conditions are not particularly limited.

The printed wiring board of the invention can be produced, for example, by etching the metal layer of the metal-clad laminate of the invention to form a circuit, and through-holes and the like may be formed in accordance with the needs. Also, the multiple-layer printed wiring board of the invention can be produced, for example, by disposing a predetermined number of sheets of the prepreg of the invention between constituent members such as inner-layer base materials and metal foils in accordance with the thickness of the desired insulation layer, followed by heating and pressing for forming. Here, the conditions for heating and pressing in this step can be suitably determined in the same manner as the conditions in the step of producing the aforesaid metal-clad laminate. Also, the inner-layer base material may be, for example, a laminate, a metal-clad laminate, or a multiple-layer printed wiring board used as an electric insulation material, and two or more kinds of these can be used in combination.

### EXAMPLES

Hereafter, the invention will be specifically described with reference to the Examples; however, the invention is not limited by these Examples.

<Synthesis of Water Soluble Phenolic Resin>

After 1 mol of phenol, 1.2 mol of 37 wt % formalin as converted in terms of formaldehyde, and 0.4 mol amount of an aqueous solution of triethylamine (concentration: 30 wt %) as converted in terms of triethylamine are allowed to react at 70° C. for 6 hours, an equi-weight mixed solvent of water and methanol is added to prepare solutions of water-soluble phenolic resin A and B having 12 wt % and 20 wt % of a solid resin component.

<Preparation of alkoxysilane Derivative Containing Composition>

(Composition 1)

To the solution of water-soluble phenolic resin A obtained in the above, 0.5 wt % of trimethoxy (glycidylmethyl) silane (with respect to the solution) is blended, and the mixture is agitated to prepare an alkoxysilane derivative containing composition 1.

(Composition 2)

To the solution of water-soluble phenolic resin A obtained in the above, 5 wt % of Trimethoxy(glycidylmethyl)silane (with respect to the solution) is blended, and the mixture is agitated to prepare an alkoxysilane derivative containing composition 2.

(Composition 3)

To the solution of water-soluble phenolic resin A obtained in the above, 10 wt % of trimethoxy(glycidylmethyl) silane (with respect to the solution) is blended, and the mixture is agitated to prepare an alkoxysilane derivative containing composition 3.

(Composition 4)

To the solution of water-soluble phenolic resin B obtained in the above, 0.5 wt % of trimethoxy(glycidylmethyl) silane (with respect to the solution) is blended, and the mixture is agitated to prepare an alkoxysilane derivative containing composition 4.

(Composition 5)

To the solution of water-soluble phenolic resin B obtained in the above, 10 wt % of trimethoxy(glycidylmethyl) silane (with respect to the solution) is blended, and the mixture is agitated to prepare an alkoxysilane derivative containing composition 5.

(Composition 6)

To an equi-weight mixed solvent of water and methanol, 10 wt % of trimethoxy (glycidylmethyl) silane is blended, and the mixture is agitated to prepare an alkoxysilane derivative containing composition 6.

<Preparation of Phenolic Resin Containing Thermosetting Resin Composition>

(Thermosetting Resin Composition 1)

A reaction tank is loaded with 150 parts by weight of tung oil, 280 parts by weight of phenol, and 0.2 part by weight of p-toluenesulfonic acid, and reaction is carried out at 90° C. for one hour. Subsequently, 200 parts by weight of paraformaldehyde and 30 parts by weight of 28 wt % ammonia water are added, and reaction is carried out at 750° C. for two hours. Thereafter, the pressure inside the reaction tank is reduced to 80 kPa (600 Torr) or lower, and condensation water is removed for two hours to obtain a tung oil denatured resol-type phenolic resin having a tung oil denaturing ratio of 35 wt %.

Subsequently, 15 parts by weight of bisphenol A type epoxy resin (trade name: EPICURON 840S, manufactured by Dainippon Ink And Chemicals, Incorporated, having a weight per epoxy equivalent of 186 to 190 g/eq), 15 parts by weight of melamine denatured novolak-type phenolic resin (having a nitrogen content of 7.0%), and 40 parts by weight of triphenyl phosphate are added to 100 parts by weight of the tung oil denatured resol-type phenolic resin obtained in the above, and the mixture is dissolved in methanol to prepare a varnish of the thermosetting resin composition 1 containing a phenolic resin having a resin content of 50 wt %.

(Thermosetting Resin Composition 2)

A varnish of the thermosetting resin composition 2 containing a phenolic resin having a resin content of 50 wt % is prepared in the same manner as the above thermosetting resin composition 1 except that 20 parts by weight of bisphenol A type epoxy resin is added.

(Thermosetting Resin Composition 3)

A varnish of the thermosetting resin composition 3 containing a phenolic resin having a resin content of 50 wt % is prepared in the same manner as the above thermosetting resin composition 1 except that 30 parts by weight of bisphenol A type epoxy resin is added.

(Thermosetting Resin Composition 4)

A varnish of the thermosetting resin composition 4 containing a phenolic resin having a resin content of 50 wt % is prepared in the same manner as the above thermosetting resin composition 1 except that no bisphenol A type epoxy resin is added.

(Thermosetting Resin Composition 5)

A reaction tank is loaded with 160 parts by weight of tung oil, 400 parts by weight of m-cresol, and 0.2 part by weight of p-toluenesulfonic acid, and reaction is carried out at 90° C. for one hour, subsequently, 200 parts by weight of paraformaldehyde and 30 parts by weight of 28 wt % ammonia water are added, and reaction is carried out at 75° C. for two hours. Thereafter, the pressure inside the reaction tank is reduced to 80 kPa (600 Torr) or lower, and condensation water is removed for two hours to obtain a rung oil denatured resol-type phenolic resin having a tung oil denaturing ratio of 35 wt %.

Subsequently, 15 parts by weight of bisphenol A type epoxy resin (trade name: D. E. R. 661, manufactured by Dow Chemical Japan Ltd., having a weight per epoxy equivalent of 500 to 560 g/eq), 70 parts by weight of melamine denatured novolak-type phenolic resin (trade name: Phenolite LA-7052, manufactured by Dainippon Ink And Chemicals, Incorporated), and 30 parts by weight of triphenyl phosphate are added to 100 parts by weight of the tung oil denatured resol-type phenolic resin obtained in the above, and the mixture is dissolved in methanol to prepare a varnish of the thermosetting resin composition 5 containing a phenolic resin having a resin content of 50 wt %.

(Thermosetting Resin Composition 6)

A varnish of the thermosetting resin composition 6 containing a phenolic resin having a resin content of 50 wt % is prepared in the same manner as the above thermosetting resin composition 5 except that bisphenol A type epoxy resin (trade name; D. E. R. 664, manufactured by Dow Chemical Japan Ltd., having a weight per epoxy equivalent of 875 to 955 g/eq) is used.

(Thermosetting Resin Composition 7)

A varnish of the thermosetting resin composition 7 containing a phenolic resin having a resin content of 50 wt % is prepared in the same manner as the above thermosetting resin composition 5 except that bisphenol F type epoxy resin (trade name: Epikote 4004P, manufactured by Japan Epoxy Resins Co., Ltd., having a weight per epoxy equivalent of 880 g/eq) is used instead of bisphenol A type phenolic resin.

(Thermosetting Resin Composition 8)

A varnish of the thermosetting resin composition 8 containing a phenolic resin having a resin content of 50 wt % is prepared in the same manner as the above thermosetting resin composition 5 except that bisphenol A type epoxy resin (trade name: D. E. R. 331, manufactured by Dow Chemical Japan Ltd., having a weight per epoxy equivalent of 186 to 190 g/eq) is used.

(Thermosetting Resin Composition 9)

A varnish of the thermosetting resin composition 9 containing a phenolic resin having a resin content of 50 wt % is prepared in the same manner as the above thermosetting resin composition 5 except that bisphenol A type epoxy resin (trade name; D. E. R. 667, manufactured by Dow Chemical Japan Ltd., having a weight per epoxy equivalent of 1600 to 1950 g/eq) is used.

(Thermosetting Resin Composition 10)

A varnish of the thermosetting resin composition 10 containing a phenolic resin having a resin content of 50 wt % is prepared in the same manner as the above thermosetting resin composition 5 except that no bisphenol A type epoxy resin is added.

<Preparation of Prepreg>

### Example 1

A paper base material (kraft paper) having a thickness of 0.2 mm and a weighing of 125 g/m² is impregnated with the alkoxysilane derivative containing composition 1 obtained in the above, followed by drying so that the impregnation amount after drying will be 18 wt %. Thereafter,the paper base material is further impregnated with the varnish of the thermosetting resin composition 1 obtained in the above, followed by drying so that the impregnation amount after drying will be 50 wt %, thereby giving a prepreg.

### Example 2

A paper base material (kraft paper) having a thickness of 0.2 mm and a weighing of 125 g/m² is impregnated with the alkoxysilane derivative containing composition 3 obtained in the above, followed by drying so that the impregnation amount after drying will be 18 wt %. Thereafter, the paper base material is further impregnated with the varnish of the thermosetting resin composition 1 obtained in the above, followed by drying so that the impregnation amount after drying will be 50 wt %, thereby giving a prepreg.

### Example 3

A paper base material (kraft paper) having a thickness of 0.2 mm and a weighing of 125 g/m² is impregnated with the alkoxysilane derivative containing composition 2 obtained in the above, followed by drying so that the impregnation amount after drying will be 18 wt %. Thereafter, the paper base material is further impregnated with the varnish of the thermosetting resin composition 3 obtained in the above, followed by drying so that the impregnation amount after drying will be 50 wt %, thereby giving a prepreg.

### Example 4

A paper base material (kraft paper) having a thickness of 0.2 mm and a weighing of 125 g/m² is impregnated with the alkoxysilane derivative containing composition 3 obtained in the above, followed by drying so that the impregnation amount after drying will be 18 wt %. Thereafter, the paper base material is further impregnated with the varnish of the thermosetting resin composition 3 obtained in the above, followed by drying so that the impregnation amount after drying will be 50 wt %, thereby giving a prepreg.

### Example 5

A paper base material (kraft paper) having a thickness of 0.2 mm and a weighing of 125 g/m² is impregnated with the alkoxysilane derivative containing composition 6 obtained in the above, followed by drying so that the impregnation amount after drying will be 10% wt. Thereafter, the paper base material is further impregnated with the varnish of the thermosetting resin composition 2 obtained in the above, followed by drying so that the impregnation amount after drying will be 50 wt %, thereby giving a prepreg.

### Example 6

A paper base material (kraft paper) having a thickness of 0.2 mm and a weighing of 125 g/m² is impregnated with the alkoxysilane derivative containing composition 4 obtained in the above, followed by drying so that the impregnation amount after drying will be 15 to 20 wt %. Thereafter, the paper base material is further impregnated with the varnish of the thermosetting resin composition 5 obtained in the above, followed by drying so that the impregnation amount after drying will be 50 to 55 wt %, thereby giving a prepreg.

### Example 7

A paper base material (kraft paper) having a thickness of 0.2 mm and a weighing of 125 g/m² is impregnated with the alkoxysilane derivative containing composition 5 obtained in the above, followed by drying so that the impregnation amount after drying will be 15 to 20 wt %. Thereafter, the paper base material is further impregnated with the varnish of the thermosetting resin composition 5 obtained in the above, followed by drying so that the impregnation amount after drying will be 50 to 55 wt %, thereby giving a prepreg.

### Example 8

A paper base material (kraft paper) having a thickness of 0.2 mm and a weighing of 125 g/m² is impregnated with the alkoxysilane derivative containing composition 5 obtained in the above, followed by drying so that the impregnation amount after drying will be 15 to 20 wt %. Thereafter, the paper base material is further impregnated with the varnish of the thermosetting resin composition 6 obtained in the above, followed by drying so that the impregnation amount after drying will be 50 to 55 wt %, thereby giving a prepreg.

### Example 9

A paper base material (kraft paper) having a thickness of 0.2 mm and a weighing of 125 g/m² is impregnated with the alkoxysilane derivative containing composition 5 obtained in the above, followed by drying so that the impregnation amount after drying will be 15 to 20 wt %. Thereafter, the paper base material is further impregnated with the varnish of the thermosetting resin composition 7 obtained in the above, followed by drying so that the impregnation amount after drying will be 50 to 55 wt %, thereby giving a prepreg.

### Comparative Example 1

A paper base material (kraft paper) having a thickness of 0.2 mm and a weighing of 125 g/m² is impregnated with the solution of water-soluble phenolic resin A obtained in the above, followed by drying so that the impregnation amount after drying will be 15 wt %. Thereafter, the paper base material is further impregnated with the varnish of the thermosetting resin composition 4 obtained in the above, followed by drying so that the impregnation amount after drying will be 50 wt %, thereby giving a prepreg.

### Comparative Example 2

A paper base material (kraft paper) having a thickness of 0.2 mm and a weighing of 125 g/m² is impregnated with the solution of water-soluble phenolic resin A obtained in the above, followed by drying so that the impregnation amount after drying will be 15 wt %. Thereafter, the paper base material is further impregnated with the varnish of the thermosetting resin composition 3 obtained in the above, followed by drying so that the impregnation amount after drying will be 50 wt %, thereby giving a prepreg.

### Comparative Example 3

A paper base material (kraft paper) having a thickness of 0.2 mm and a weighing of 125 g/m² is impregnated with the solution of water-soluble phenolic resin B obtained in the above, followed by drying so that the impregnation amount after drying will be 17 to 25 wt %. Thereafter, the paper base material is further impregnated with the varnish of the thermosetting resin composition 10 obtained in the above, followed by drying so that the impregnation amount after drying will be 50 to 55 wt %, thereby giving a prepreg.

### Comparative Example 4

A paper base material (kraft paper) having a thickness of 0.2 mm and a weighing of 125 g/m² is impregnated with the solution of water-soluble phenolic resin B obtained in the above, followed by drying so that the impregnation amount after drying will be 17 to 25 wt %. Thereafter, the paper base material is further impregnated with the varnish of the thermosetting resin composition 8 obtained in the above, followed by drying so that the impregnation amount after drying will be 50 to 55 wt %, thereby giving a prepreg.

### Comparative Example 5

A paper base material (kraft paper) having a thickness of 0.2 mm and a weighing of 125 g/m² is impregnated with the solution of water-soluble phenolic resin B obtained in the above, followed by drying so that the impregnation amount after drying will be 17 to 25 wt %. Thereafter, the paper base material is further impregnated with the varnish of the thermosetting resin composition 9 obtained in the above, followed by drying so that the impregnation amount after drying will be 50 to 55 wt %, thereby giving a prepreg.

<Preparation of Two-Sided Copper-Clad Laminate>

Eight sheets of the prepreg of Examples 1 to 9 and Comparative Examples 1 to 5, respectively, are superposed on one another. On both surfaces thereof, a copper foil with an adhesive attached thereto and having a copper foil thickness of 35 μm is superposed so that the adhesive layer will be on the prepreg side, followed by heating and pressing at a temperature of 170° C. and a pressure of 15 MPa for 90 minutes to obtain a two-sided copper-clad laminate having a thickness of 1.6 mm.

<Evaluation>

Solder heat resistance, reflow heat resistance, flame retardancy, punching processability, varnish gel time, prepreg resin flow, and insulation resistance are evaluated on the above prepreg or two-sided copper-clad laminate of Examples 1 to 9 and Comparative Examples 1 to 6 according to the following method. The results are shown in Tables 1 and 2.

(Solder Heat Resistance)

Each of the two-sided copper-clad laminates are let to float in a solder tank of 260° C. so that the copper foil surface will be in contact, and the period of time (seconds) that is needed for swelling to occur is measured.

(Reflow Heat Resistance)

A circuit is formed on each of the two-side copper-clad laminates by the printing method. A printed wiring board having a residual copper ratio of 70% prepared by etching the copper foil is let to flow in a reflow apparatus, and the presence or absence of swelling occurrence is observed by eye inspection. The number of tests is two for each sample. The absence of swelling is denoted with ◯, and the presence of swelling is denoted with ×. The temperature setting of the reflow apparatus is carried out by measuring the maximum temperature of the base material surface of the printed wiring board.

(Flame Retardancy)

The copper foil is etched on the whole surface from each of the two-sided copper-clad laminates, and a test piece of 127×13 mm is cut out. According to the UL method, this test piece is held so that the longitudinal side will be vertical. A flame is brought into contact at the bottom of the test piece for 10 seconds with the use of a burner two times, and the period of time until the flame is extinguished is measured for evaluation.

(Punching Processability)

Each of the two-sided copper-clad laminates obtained by etching the copper foil on the whole surface is subjected to a stamping-out process with the use of a test mold having a punch diameter of 1.0 to 1.2 mm, a hole pitch of 2.54 mm, and having 24 holes with different surface temperatures thereof (60, 80, and 100° C.) The peripheries around the holes of each of the two-sided copper-clad laminates that are stamped out are observed by eye inspection, and the state thereof is denoted with symbols ◯: no peeling-off or haloing is present, Δ: a little peeling-off or haloing is present, and ×: peeling-off or haloing is present.

(Varnish Gel Time)

On the varnish of the thermosetting resin composition used in each prepreg, the gel time at 160° C. is measured after 0, 7, 14, and 21 days have passed after blending.

(Prepreg Resin Flow)

Five sheets of each prepreg after 0, 7, 14, and 21 days have passed, respectively, are superposed on one another, followed by heating and pressing at 130° C. and under 10 MPa for 7 minutes The amount of lost resin (resin flow) is calculated on the basis of the weight before and after heating and pressing.

(Insulation Resistance)

The insulation resistance is measured in accordance with JIS C 6481.

TABLE 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| alkoxysilane | | 1 | 3 | 2 | 3 | 6 | 4 | 5 | 5 | 5 |
| derivative | | | | | | | | | | |
| containing | | | | | | | | | | |
| composition No | | | | | | | | | | |
| water-soluble | | A | A | A | A | — | B | B | B | B |
| phenolic resin | | | | | | | | | | |
| trimethoxy(glycidyl | | 0.5 | 10 | 5 | 10 | 10 | 0.5 | 10 | 10 | 10 |
| methyl)silane | | | | | | | | | | |
| concentration (wt %) | | | | | | | | | | |
| thermosetting resin | | 1 | 1 | 3 | 3 | 2 | 5 | 5 | 6 | 7 |
| composition No. | | | | | | | | | | |
| amount of blended | | 15 | 15 | 30 | 30 | 20 | 15 | 15 | 15 | 15 |
| epoxy resin | | | | | | | | | | |
| (parts by weight) | | | | | | | | | | |
| weight per epoxy | | 186˜190 | 186˜190 | 186˜190 | 186˜190 | 186˜190 | 500˜560 | 500˜560 | 875˜955 | 880 |
| equivalent g/eg) | | | | | | | | | | |
| solder heat | | 60 or | 60 or | 60 or | 60 or | 60 or | 60 or | 60 or | 60 or | 60 or |
| resistance | | more | more | more | more | more | more | more | more | more |
| reflow heat | 240° C. | ◯◯ | ◯◯ | ◯◯ | ◯◯ | ◯◯ | ◯◯ | ◯◯ | ◯◯ | ◯◯ |
| resistance | 250° C. | ◯◯ | ◯◯ | ◯◯ | ◯◯ | ◯◯ | ◯◯ | ◯◯ | ◯◯ | ◯◯ |
| | 260° C. | XX | ◯X | ◯X | ◯◯ | XX | XX | ◯X | ◯X | ◯X |
| flame retardancy | | 94V-0 | 94V-0 | 94V-0 | 94V-0 | 94V-0 | 94V-0 | 94V-0 | 94V-0 | 94V-0 |
| (UL method) | | | | | | | | | | |
| punching | 60° C. | ◯˜Δ | ◯˜Δ | ◯˜Δ | ◯˜Δ | ◯˜Δ | ◯˜Δ | ◯˜Δ | ◯ | ◯ |
| processabil- | 80° C. | ◯ | ◯ | ◯ | ◯ | ◯ | ◯ | ◯ | ◯ | ◯ |
| ity | 100° C. | ◯ | ◯ | ◯ | ◯ | ◯ | ◯ | ◯ | ◯˜Δ | ◯˜Δ |
| varnish gel | after | 280 | 280 | 280 | 280 | 280 | 330 | 330 | 330 | 330 |
| time | 0 days | | | | | | | | | |
| (seconds) | after | 260 | 260 | 250 | 250 | 255 | 315 | 315 | 320 | 320 |
| | 7 days | | | | | | | | | |
| | after | 230 | 230 | 220 | 220 | 225 | 300 | 300 | 300 | 300 |
| | 14 days | | | | | | | | | |
| | after | 210 | 210 | 185 | 185 | 200 | 290 | 290 | 290 | 290 |
| | 21 days | | | | | | | | | |
| prepreg | after | 7 | 7 | 7 | 7 | 7 | 7 | 7 | 7 | 7 |
| resin flow | 0 days | | | | | | | | | |
| (%) | after | 5.8 | 5.8 | 5.5 | 5.5 | 5.8 | 6.3 | 6.3 | 6.5 | 6.5 |
| | 7 days | | | | | | | | | |
| | after | 3.8 | 3.7 | 3 | 3 | 3.5 | 5.5 | 5.5 | 5.8 | 5.7 |
| | 14 days | | | | | | | | | |
| | after | 3 | 3.1 | 1.6 | 1.5 | 2.4 | 5 | 5 | 5.2 | 5.1 |
| | 21 days | | | | | | | | | |

| | | | | | | | | | |
|---|---|---|---|---|---|---|---|---|---|
| insulation | 5 × 10¹⁰ | 7 × 10⁹ | 3 × 10⁹ | 1 × 10⁹ | 1 × 10⁹ | — | — | — | — |
| resistance (D-2/100) | | | | | | | | | |

TABLE 2

| | | Comparative | Comparative | Comparative | Comparative | Comparative |
|---|---|---|---|---|---|---|
| | | Example 1 | Example 2 | Example 3 | Example 4 | Example 5 |
| alkoxysilane | | — | — | — | — | — |
| derivative | | | | | | |
| containing | | | | | | |
| composition No. | | | | | | |
| water-soluble | | A | A | B | B | B |
| phenolic resin | | | | | | |
| trimethoxy(glycidyl | | 0 | 0 | 0 | 0 | 0 |
| methyl)silane | | | | | | |
| concentration (wt %) | | | | | | |
| thermosetting resin | | 4 | 3 | 10 | 8 | 9 |
| composition No. | | | | | | |
| amount of blended | | 0 | 30 | 0 | 15 | 15 |
| epoxy resin | | | | | | |
| (parts by weight) | | | | | | |
| weight per epoxy | | — | 186˜190 | — | 186˜190 | 1600˜1950 |
| equivalent g/eg) | | | | | | |
| solder heat | | 40 | 45 | 30 | 60 or more | 40 |
| resistance | | | | | | |
| reflow heat | 240° C. | ◯◯ | ◯◯ | ◯◯ | ◯◯ | ◯◯ |
| resistance | 250° C. | XX | XX | XX | ◯◯ | XX |
| | 260° C. | XX | XX | XX | XX | XX |
| flame retardancy | | 94V-1 | 94V-0 | 94V-0 | 94V-0 | 94V-0 |
| (UL method) | | | | | | |
| punching | 60° C. | ◯˜Δ | ◯˜Δ | ◯˜Δ | X | ◯ |
| processabil- | 80° C. | ◯ | ◯ | ◯ | Δ | ◯ |
| ity | 100° C. | ◯ | ◯ | ◯ | ◯˜Δ | ◯˜Δ |
| varnish gel | after | 280 | 280 | 330 | 330 | 330 |
| time | 0 days | | | | | |
| (seconds) | after | 270 | 250 | 320 | 280 | 320 |
| | 7 days | | | | | |
| | after | 255 | 220 | 305 | 220 | 300 |
| | 14 days | | | | | |
| | after | 245 | 185 | 295 | 160 | 295 |
| | 21 days | | | | | |
| prepreg | after | 7 | 7 | 7 | 7 | 7 |
| resin flow | 0 days | | | | | |
| (%)⁾ | after | 5.5 | 5.5 | 6.7 | 2.5 | 6.7 |
| | 7 days | | | | | |
| | after | 5.8 | 3.1 | 6 | 1 | 5.8 |
| | 14 days | | | | | |
| | after | 5.2 | 1.5 | 5.4 | 0.5 | 5.4 |
| | 21 days | | | | | |

| | | | | | |
|---|---|---|---|---|---|
| insulation | 3 × 10¹⁰ | 3 × 10⁹ | — | — | — |
| resistance (D-2/100) | | | | | |

From the above, it will be understood that the prepregs of the Examples obtained by impregnating a paper base material with an alkoxysilane derivative containing composition in advance and then impregnating the paper base material with a phenolic resin containing thermosetting resin composition as well as the two-sided copper-clad laminates using the same are excellent in all of heat resistance, flame retardancy, punching processability, and insulation.

In the meantime, the prepreg obtained by impregnating a paper base material (kraft paper) having a thickness of 0.2 mm and a weighing of 125 g/m² with the above water-soluble phenolic resin B, followed by drying so that the impregnation amount after drying will be 17 to 25%, and thereafter further impregnating the paper base material with the varnish of the above thermosetting resin composition 5, followed by drying so that the impregnation amount after drying will be 50 to 55 wt % (Example 10), the prepreg produced in the same manner as in Example 10 except that The thermosetting resin composition 6 is used:instead of the thermosetting resin composition 5 (Example 11), and the prepreg produced in the same manner as in Example 10 except that the thermosetting resin composition 7 is used instead of the thermosetting resin composition 5 (Example 12) are evaluated in the same manner as in the above Example 1. From this evaluation, it is found out that a prepreg being excellent in heat resistance, punching processability, and flame retardancy as well as a two-sided copper-clad laminate using the same have been obtained. The results are shown in Table 3.

TABLE 3

| | | Example | Example | Example |
|---|---|---|---|---|
| | | 10 | 11 | 12 |
| alkoxysilane | | — | — | — |
| derivative | | | | |
| containing | | | | |
| composition No. | | | | |
| water-soluble | | B | B | B |
| phenolic resin | | | | |
| trimethoxy (glycidyl | | 0 | 0 | 0 |
| methyl) silane | | | | |
| concentration (wt %) | | | | |
| thermosetting resin | | 5 | 6 | 7 |
| composition No | | | | |
| amount of blended | | 15 | 15 | 15 |
| epoxy resin | | | | |
| (parts by weight) | | | | |
| weight per epoxy | | 500˜560 | 500˜560 | 500˜560 |
| equivalent g/eg) | | | | |
| solder heat | | 60 or | 60 or | 60 or |
| resistance | | more | more | more |
| reflow heat | 240° C. | ◯◯ | ◯◯ | ◯◯ |
| resistance | 250° C. | ◯◯ | ◯◯ | ◯◯ |
| | 260° C. | XX | XX | XX |
| flame retardancy | | 94V-0 | 94V-0 | 94V-0 |
| (UL method) | | | | |
| punching | 60° C. | ◯˜Δ | ◯ | ◯ |
| processabil- | 80° C. | ◯ | ◯ | ◯ |
| ity | 100° C. | ◯ | ◯˜Δ | ◯˜Δ |
| varnish gel | after | 330 | 330 | 330 |
| time | 0 days | | | |
| (seconds) | after | 315 | 320 | 320 |
| | 7 days | | | |
| | after | 300 | 300 | 300 |
| | 14 days | | | |
| | after | 290 | 290 | 290 |
| | 21 days | | | |
| prepreg | after | 7 | 7 | 7 |
| resin flow | 0 days | | | |
| (%) | after | 6.3 | 6.5 | 6.5 |
| | 7 days | | | |
| | after | 5.5 | 5.8 | 5.7 |
| | 14 days | | | |
| | after | 5 | 5.2 | 5.1 |
| | 21 days | | | |

| | | | |
|---|---|---|---|
| insulation | — | — | — |
| resistance (D-2/100) | | | |

The reason why the good results shown in Table 3 have been obtained in Examples 10 to 12 seems to be mainly due to the fact that a resin composition containing a vegetable oil denatured resol-type phenolic resin, an epoxy resin having a weight per epoxy equivalent of 400 to 1000 g/eq, a melamine denatured novolak-type phenolic resin, and a phosphoric acid ester is used as the thermosetting resin composition.

1. A prepreg obtained by impregnating a paper base material in advance with a composition containing an alkoxysilane derivative and/or condensate of an alkoxysilane derivative, and then impregnating the paper base material with a thermosetting resin composition containing a phenolic resin, followed by heating and drying.

2. The prepreg of claim 1, wherein the alkoxysilane derivative and/or condensate of an alkoxysilane derivative has at least one epoxy group.

3. The prepreg of claim 1, wherein the alkoxysilane derivative has a structure represented by the following formula: 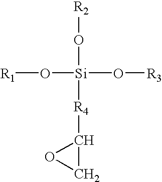
where R₁ to R₃ are independently a hydrogen atom or an alkyl group having one to four carbon atoms, and R₄ is a divalent organic group.

4. The prepreg of claim 1, wherein the composition containing an alkoxysilane derivative and/or condensate of an alkoxysilane derivative further contains a water-soluble phenolic resin, and contains 0.5 to 10 wt % of the alkoxysilane derivative and/or condensate of an alkoxysilane derivative.

5. The prepreg of claim 1, wherein the thermosetting resin composition further contains 2 to 30 parts by weight of an epoxy resin relative to 100 parts by weight of the phenolic resin.

6. The prepreg of claim 1, wherein the phenolic resin is a vegetable oil denatured phenolic resin.

7. The prepreg of claim 1, wherein the thermosetting resin composition further contains a halogen-free nitrogen-based flame retardant and/or phosphorus-based flame retardant.

8. The prepreg of claim 1, wherein the phenolic resin is a vegetable oil denatured resol-type phenolic resin, and the thermosetting resin composition further contains an epoxy resin, a melamine denatured novolak-type phenolic resin, and a phosphoric acid ester.

9. The prepreg of claim 1, wherein the phenolic resin is a vegetable oil denatured resol-type phenolic resin, and the thermosetting resin composition further contains 5 to 40 parts by weight of an epoxy resin, 70 to 150 parts by weight of a melamine denatured novolak-type phenolic resin, and 30 to 80 parts by weight of a phosphoric acid ester relative to 100 parts by weight of the vegetable oil denatured resol-type phenolic resin.

10. The prepreg of claim 8, wherein a weight per epoxy equivalent of the epoxy resin is 400 to 1000 g/eq.

11. The prepreg of claim 5, wherein the epoxy resin is a bisphenol A type epoxy resin that does not contain a halogen.

12. A laminate obtained by superposing a predetermined number of sheets of a prepreg according to claim 1, followed by heating and pressing.

13. A metal-clad laminate obtained by superposing a predetermined number of sheets of a prepreg claim 1 and then disposing a metal foil on one or both surfaces thereof, followed by heating and pressing.

14. A printed wiring board obtained by etching a metal layer of a metal-clad laminate according to claim 13.

15. A resin composition containing a vegetable oil denatured resol-type phenolic resin, an epoxy resin, a melamine denatured novolak-type phenolic resin, and a phosphoric acid ester, wherein the epoxy resin has a weight per epoxy equivalent of 400 to 1000 g/eq.

16. The resin composition of claim 15, containing 5 to 40 parts by weight of the epoxy resin, 70 to 150 parts by weight of the melamine denatured novolak-type phenolic resin, and 30 to 80 parts by weight of the phosphoric acid ester relative to 100 parts by weight of the vegetable oil denatured resol-type phenolic resin.

17. A prepreg obtained by impregnating a base material with a resin composition according to claim 15, followed by drying.

18. A laminate obtained by superposing a predetermined number of sheets of a prepreg according to claim 17, followed by heating and pressing.

19. A metal-clad laminate obtained by superposing a predetermined number of sheets of a prepreg according to claim 17 and then disposing a metal foil on one or both surfaces thereof, followed by heating and pressing.
